(19) United States
(12) Patent Application Publication
(10) Pub. No.: US 2021/0368837 A1
(43) Pub. Date: Dec. 2, 2021

(54) BOEHMERIA NIVEA COMPOSITIONS AND METHODS FOR TASTE MODULATION

(71) Applicant: INTERNATIONAL FLAVORS & FRAGRANCES INC., Union Beach, NJ (US)

(72) Inventors: Hou Wu, East Brunswick, NJ (US); Michelle Eve Huber, Cream Ridge, NJ (US); Jung-A Kim, Edgewater, NJ (US); Li Chen, Belle Mead, NJ (US); Hassan Mustaq Ubaideen, Aberdeen, NJ (US); Thumpalasseril V. John, Morganvilie, NJ (US); Xiaodong LI, Middletown, NJ (US)

(73) Assignee: INTERNATIONAL FLAVORS & FRAGRANCES INC., Union Beach, NJ (US)

(21) Appl. No.: 17/311,135

(22) PCT Filed: Dec. 5, 2019
(86) PCT No.: PCT/US2019/064587

§ 371 Date: Jun. 4, 2021

Related U.S. Application Data
(60) Provisional application No. 62/776,139, filed on Dec. 6, 2018.

(51) Int. Cl. A23L 27/10; A23L 33/105; A23L 33/125; A23L 2/60; A23L 2/56

(52) U.S. Cl. CPC A23L 27/10; A23L 33/105; A23L 2/56; A23L 2/60; A23L 33/125

(57) ABSTRACT

A Boehmeria nivea extract, as well as a glucosylated B. nivea extract and dicarboxylic acids obtained from B. nivea are described for use in compositions and methods for enhancing the sweetness and mouthfeel of a consumable containing a carbohydrate sweetener or flavoring, or for masking the off-flavor of a proteinaceous component of a consumable.

This application claims benefit of priority to U.S. Provisional Patent Application Ser. No. 62/776,139, filed Dec. 6, 2018, the content of which is incorporated herein by reference in its entirety.

### INTRODUCTION

### Background

Boehmeria nivea, commonly known as China grass, white ramie, green ramie, ramie or rhea, is an upright deciduous, monoecious sub-shrub or shrub in the nettle family that typically grows to 8-10 feet tall. It is best known for providing a textile fiber of excellent strength and quality from the inner bark of the stems. In addition, B. nivea leaves lower cholesterol, improve fatty liver, and prevent diabetes. By adding barley tea to soften the astringent and grassy off-flavor of B. nivea leaf tea, B. nivea leaf tea becomes drinkable (KR 101358316 B1). Further, a cellulose powder from ramie leaves is suitable as an excipient for compression molding in medical, food and industrial application ((U.S. Pat. No. 7,939,101). Moreover, B. nivea extract could be used in the pickles, soy sauce or crab fermented soy sauce (KR 102014147467 A and KR 02014147466 A) as well as in seasonings (KR 1020140072595 A) and broths (KR 102014044498). However, the use of B. nivea extract for providing sweetness and mouthfeel enhancement as well as off-flavor masking functions in a consumable has not been described.

### SUMMARY OF THE INVENTION

This invention provides a consumable composed of a carbohydrate sweetener or flavoring and a B. nivea extract or at least one dicarboxylic acid, wherein the consumable may be a food product, pharmaceutical composition, a dietary supplement, a nutraceutical, a dental hygienic composition, a tabletop sweetener, a beverage, or a cosmetic product. In some embodiments, the dicarboxylic acid has the structure of Formula I:

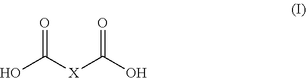

wherein X is a C₆-C₁₂ alkyl or alkenyl group. In certain embodiments, the dicarboxylic acid is saturated, mono-unsaturated or di-unsaturated and includes, e.g., decanedioic acid, 2-dodecenedioic acid, 3-dodecenedioic acid, or a combination thereof. In other embodiments, the B. nivea extract is glucosylated. A method for enhancing the sweetness or mouthfeel of a consumable including a carbohydrate sweetener or flavoring is also provided, which includes the step of adding at least one dicarboxylic acid or a B. nivea extract to the consumable. Moreover, this invention provides a consumable and method for masking a proteinaceous off-flavor of a consumable by adding a B. nivea extract to the consumable.

### DETAILED DESCRIPTION OF THE INVENTION

It has now been found that an extract of B. nivea, as well as a glucosylated extract thereof and dicarboxylic acids isolated from B. nivea, exhibit a sweet enhancement effect as well as mouthfeel modifying functionalities. In addition, the B. nivea extract, glucosylated extract, and dicarboxylic acids mask off-tastes associated with proteinaceous components of a consumable. Accordingly, the present invention provides compositions and methods, which use the B. nivea extract, the glycosylated B. nivea extract and one or more dicarboxylic acids isolated from the B. nivea extract as additives to enhance the sweetness and mouthfeel of a consumable and/or mask proteinaceous off-flavor in a consumable.

As used herein, a B. nivea extract also referred to herein as a ramie extract, is an aqueous/alcohol extract of the leaves of B. nivea. In certain embodiments, a ramie extract of the invention is a water/ethanol extract of the leaves of B. nivea. In particular embodiments, leaves of B. nivea are extracted with a 60-85%, or more preferably 65-80% ethanol solution. In certain embodiments, the B. nivea extract is enriched for dicarboxylic acids. In particular embodiments, the B. nivea extract is enriched for one or both of sebacic acid, 2-dodecenedioic acid (traumatic acid; CAS No. 6402-36-4), 3-dodecenedioic acid (CAS No. 189034-80-8), or a combination thereof. These compounds may have a number of isomers such as positional isomers. Accordingly, the compounds described herein include isomeric mixtures as well as single isomers that may be separated using techniques known in the art. Suitable techniques include chromatography such as high-performance liquid chromatography, referred to as HPLC, and particularly silica gel chromatography and gas chromatography trapping known as GC trapping.

The glucosylated B. nivea extract may be produced by obtaining a B. nivea extract and transglycosylating the B. nivea extract to add glucose units, for example, one, two, three, four, five, or more than five glucose units, to molecules therein. Transglycosylation of the B. nivea extract can be carried out with any suitable enzyme including, but not limited to, a pullulanase and isomaltase (Lobov, et al. (1991) Agric. Biol. Chem. 55:2959-2965), β-galactosidase (Kitahata, et al. (1989) Agric. Biol. Chem. 53:2923-2928), dextrine saccharase (Yamamoto, et al. (1994) Biosci. Biotech. Biochem. 58:1657-1661) or cyclodextrin glucotransferase, with pullulan, maltose, lactose, partially hydrolyzed starch and maltodextrin being donors. In certain embodiments, the B. nivea extract is transglycosylated with cyclodextrin glucotransferase (e.g., TORUZYME®, a cyclodextrin glucotransferase from Bacillus licheniformis) in the presence of maltodextrin (e.g., maltodextrin DE 10). Once transglycosylation of the B. nivea extract is complete, the enzyme can be inactivated by, e.g., heat treatment. The resulting product is preferably modified with glycerin or glycerol and optionally concentrated, e.g., by rotary evaporation.

A “dicarboxylic acid” refers to a compound having the structure of Formula I:

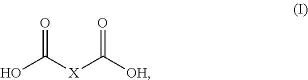

wherein X is a C₆-C₁₂ alkyl or alkenyl group. In this formula, as in all structural formulas used hereinafter, it is understood that all carbon valences not shown here are satisfied by the groups illustrated and by hydrogen atoms.

An “alkyl” group refers to a saturated aliphatic hydrocarbon group. The alkyl group may be a straight or linear chain and may optionally be substituted. The alkyl group may have 6 to 12 carbon atoms, i.e., C₆-C₁₂, wherein the numerical range “6 to 12” refers to each integer in the given range; e.g., “6 to 12 carbon atoms” means that the alkyl group may have 6 carbon atom, 7 carbon atoms, 8 carbon atoms, etc., up to and including 12 carbon atoms. By way of example, “C₈-C₁₂ alkyl” indicates that there are eight to twelve carbon atoms in the alkyl chain, i.e., the alkyl chain is selected from among octyl, nonyl, decyl, undecyl, and dodecyl. Thus, C₈-C₁₂ alkyl includes C₈-C₉ alkyl and C₈-C₁₀ alkyl. Alkyl groups in accordance with Formula I include hexyl, heptyl, octyl, nonyl, decyl, undecyl, and dodecyl. In certain embodiments, the alkyl group is a C₈-C₁₀ alkyl group. In other embodiments, the alkyl group is an octyl or decyl group.

The term “alkenyl” refers to a type of alkyl group in which at least two atoms of the alkyl group form a double bond. The alkenyl moiety may be a straight or linear chain and may optionally be substituted. As with the alkyl group, the alkenyl group preferably has 6 to 12 carbon atoms, i.e., C₆-C₁₂, wherein the numerical range “6 to 12” refers to each integer in the given range. In some embodiments, the alkenyl group has one double bond, i.e., mono-unsaturated. In other embodiments, the alkenyl group has two double bonds, i.e., di-unsaturated. Double bonds may be located at the ends of the alkenyl chain or in the middle of the alkenyl chain. Preferably, a double bond is located at the end of the alkenyl chain. Non-limiting examples of alkenyl groups include —CH═CH—(CH₂)₄—, —CH═CH—(CH₂)₆—, —CH═CH—(CH₂)₈—, and —CH═CH—(CH₈)₁₀—.

In some embodiments, the dicarboxylic acid is a saturated dicarboxylic acid. Exemplary saturated dicarboxylic acids include octanedioic acid (suberic acid; CAS No. 505-48-6), nonanedioic acid (azelaic acid; CAS No. 123-99-9), decanedioic acid (sebacic acid; CAS No. 111-20-6), undecanedioic acid (CAS No. 1852-04-6), dodecanedioic acid (CAS No. 693-23-2), and tridecanedioic acid (Brassylic acid; CAS No. 5050-52-2). In other embodiments, the dicarboxylic acid is a mono-unsaturated dicarboxylic acid. Exemplary mono-unsaturated dicarboxylic acids include oct-2-enedioic acid (CAS No. 5698-50-0), non-2-enedioic acid (CAS No. 104263-77-6), dec-2-enedioic acid (CAS No. 37443-67-7), undec-2-enedioic acid (CAS No. 82342-32-3), 2-dodecenedioic acid (traumatic acid; CAS No. 6402-36-4), 3-dodecenedioic acid (CAS No. 189034-80-8) and tridec-2-enedioic acid. In further embodiments, the dicarboxylic acid is a di-unsaturated dicarboxylic acid. Exemplary di-unsaturated dicarboxylic acids include oct-2,4-dienedioic acid, non-2,4-dienedioic acid, dec-2,4-dienedioic acid, undec-2,4-dienedioic acid, dodeca-2,4-dienedioic acid, and trideca-2,4-dienedioic acid. While the above referenced examples include linear dicarboxylic acids, branched dicarboxylic acids are also considered to be within the scope of this invention. Thus, in some embodiments, the dicarboxylic acid is a linear dicarboxylic acid. In other embodiments, the dicarboxylic acid is a branched dicarboxylic acid. Further, a mono- and di-unsaturated dicarboxylic acid may be either a cis and trans isomer. In one embodiment, the dicarboxylic acid is decanedioic acid (also referred to herein as sebacic acid). In another embodiment, the dicarboxylic acid is 2-dodecenedioic acid (also referred to herein as traumatic acid) and/or the isomer 3-dodecenedioic acid. In other embodiments, the invention embraces combinations of dicarboxylic acids, e.g., a combination of sebacic acid and traumatic acid. In particular embodiments, the weight ratio of traumatic acid (and/or isomer thereof) to sebacic acid is at least 1:1, 10:1, 20:1, 40:1, 50:1, 60:1, 70:1, 80:1, 90:1 or 100:1.

Isolated dicarboxylic acids or extracts enriched for one or more dicarboxylic acids are ideally obtained by solvent extraction and/or chromatographic fractionation. For example, dicarboxylic acids may be isolated by sequential alkalization, acidification and ether extraction (Brown & Freure (1959) Can. J. Chem. 37:2042-2046); or extraction with an aqueous solution at elevated temperatures (e.g., 50° C. to 100° C.) followed by separation of the two immiscible phases and precipitation of the dicarboxylic acids by cooling to aqueous phase (U.S. Pat. No. 2,798,093). Chromatographic fractionation typically includes column chromatography and may based on molecular sizing, charge, solubility and/or polarity. Depending on the type of chromatographic method, column chromatography can be carried out with matrix materials composed of, for example, dextran, agarose, polyacrylamide or silica and can include solvents such as dimethyl sulfoxide, pyridine, water, dimethylformamide, methanol, saline, ethylene dichloride, chloroform, propanol, ethanol, isobutanol, formamide, methylene dichloride, butanol, acetonitrile, isopropanol, tetrahydrofuran, dioxane, chloroform/dichloromethane, etc. Typically, the product of the chromatographic step is collected in multiple fractions, which may then be tested for the presence of the desired compound using any suitable analytical technique (e.g., thin layer chromatography, mass spectrometry). Fractions enriched in the desired compound may then be selected for further purification.

Alternatively, the dicarboxylic acid may be synthesized. For example, sebacic acid can be synthesized by castor oil electrooxidation (U.S. Pat. No. 4,237,317), which produces high purity sebacic acid from readily available adipic acid. The process includes the steps of partially esterifying adipic acid to form monomethyl adipate, subjecting the potassium salt of monomethyl adipate in a mixture of methanol and water to electrolysis to give dimethyl sebacate, and hydrolyzing the dimethyl sebacate to sebacic acid. By way of further illustration, traumatic acid can be synthesized by peroxide-catalyzed radical addition of carbon tetrachloride to 10-undecenoic acid, fuming with nitric acid to yield the crystalline chloro-diacid and treatment with aqueous alkali to afford the desired dicarboxylic acid (Prakasa Rao & Navak (1975) Synthesis 9:608-9). In yet other embodiments, the dicarboxylic acid is obtained from a commercial source such as Cayman Chemical (Ann Arbor, Mich.) or Sigma-Aldrich (St. Louis, Mo.). While salts of the dicarboxylic acids may be used in this invention, preferably the dicarboxylic acids are not derivatized or conjugated to another molecule, i.e., the dicarboxylic acids are unconjugated dicarboxylic acids.

The B. nivea extracts and dicarboxylic acids described herein enhance the taste and flavor of consumables. The taste and flavor profile of a consumable including the B. nivea extracts and/or dicarboxylic acids of the invention may be enhanced or more intense, e.g., 5%, 10%, 20%, 30% or more intense than a comparative taste and flavor profile of a comparative consumable which does not include the B. nivea extracts or dicarboxylic acids as exogenous additives. Further, the mouthfeel, in particular sweet and/or fatty mouthfeel, of a consumable including the B. nivea extracts and/or dicarboxylic acids may be improved in relation to the mouthfeel of a comparative consumable that does not include the B. nivea extracts and dicarboxylic acids.

In particular embodiments, the B. nivea extracts and dicarboxylic acids of the invention enhance the sweetness and mouthfeel of a consumable containing a carbohydrate sweetener or flavoring. As used herein, the term “sweetness” or “sweetness intensity” refers to the relative strength of sweet sensation as observed or experienced by an individual, e.g., a human, or a degree or amount of sweetness detected by a taster, for example on the scale from 0 (none) to 8 (very strong) used in sensory evaluations according to the procedure described in American Society for Testing Materials, Special Technical Publication-434: “Manual on Sensory Testing Methods,” ASTM International, West Conshohocken, Pa. (1996). The mouthfeel of a substance relates to the physical sensations in the mouth produced by a particular food. By way of illustration, a “sugary mouthfeel” is the physical sensation observed or experienced by an individual, e.g., a human, upon consumption of a sugar. In accordance with the present invention, B. nivea extracts and dicarboxylic acids enhance one or both of sweet/sugary mouthfeel and optionally fatty mouthfeel.

In certain embodiments, the B. nivea extracts and dicarboxylic acids of the invention mask the proteinaceous off-flavor of a proteinaceous component of a consumable. A “proteinaceous off-flavor” or “off-flavor of a proteinaceous component” refers to a bitter, sour, fishy, metallic and/or unpleasant taste of an amino acid, protein hydrolysate or protein component of a consumable. The term “mask” or “masking” as used herein, is defined as covering, disguising, and/or obscuring the taste of an amino acid, protein hydrolysate or protein component by the addition of a B. nivea extract and/or dicarboxylic acids, wherein the amino acid, protein hydrolysate or protein component remains unchanged, but its unpleasant taste is not perceived by a human consuming said consumable. In some embodiments, the proteinaceous off-flavor masked by B. nivea extracts or dicarboxylic acids of the invention is that associated with a plant protein or milk of grass-eating animals.

As used herein, a consumable includes all food products, pharmaceutical compositions, dietary supplements, nutraceuticals, dental hygienic compositions, tabletop sweeteners, beverages, or cosmetic products. In some embodiments, the consumable includes one or more carbohydrate sweeteners or flavorings. The carbohydrate sweetener or flavoring can be present in the consumable inherently (e.g., in food products containing fruits) or the carbohydrate sweetener or flavoring is added into the consumable. Suitable carbohydrate sweeteners of the present invention include, but are not limited to, sucrose, fructose, glucose, high fructose corn syrup (containing fructose and glucose), xylose, arabinose, rhamnose, and sugar alcohols, such as erythritol, xylitol, mannitol, sorbitol, or inositol. In one embodiment, the sweetener is sucrose, fructose, glucose, high fructose corn syrup, xylose, arabinose or rhamnose, preferably sucrose, fructose, or glucose. In one aspect of this embodiment, the carbohydrate sweetener is sucrose. In another aspect of this embodiment, the carbohydrate sweetener is glucose. In another aspect of this embodiment, the carbohydrate sweetener is fructose. In another embodiment, the carbohydrate sweetener is a sugar alcohol, e.g., erythritol, xylitol, mannitol, sorbitol, or inositol.

Flavorings of use in this invention include, but are not limited to, Natural Sweet Flavor #2 (WO 2012/129451), stevioside, rebaudioside A, rebaudioside B, rebaudioside C, rebaudioside D, rebaudioside E, rebaudioside F, dulcoside A, dulcoside B, stevia, alpha-glucosyl stevia, fructosyl stevia, galactosyl stevia, beta-glucosyl stevia, siamenoside, mogroside IV, mogroside V, Luo Han Guo sweetener, monatin and its salts, glycyrrhizic acid and its salts (e.g., as found in MAGNASWEET), curculin, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, cyclocarioside I, or a combination thereof. In certain embodiments, the flavoring is Natural Sweet Flavor #2 (also known as NSF-02), which contains glucosylated steviol glycosides and dextrin.

When added to a consumable as an additive, a B. nivea extract (including glucosylated extract) and/or dicarboxylic acid is used in an amount effective to enhance the sweetness or mouthfeel of a carbohydrate sweetener or flavoring without exhibiting any off-taste. Any amount of the B. nivea extract or dicarboxylic acid that provides the desired degree of sweetness or mouthfeel enhancement can be used. Similarly, a B. nivea extract and/or dicarboxylic acid is used in an amount effective to reduce or mask the off-flavor of a proteinaceous component in a consumable. Preferably, the amount of B. nivea extract or dicarboxylic acid present in the consumable is an amount as low as 0.05 ppm, in an amount as low as 0.5 ppm, in an amount as low as 1 ppm, or in an amount as low as 10 ppm. The B. nivea extract or dicarboxylic acid can be included in the consumable in an amount that is as high as 100 ppm, in an amount as high as 500 ppm, or in an amount as high as 1000 ppm. The B. nivea extract or dicarboxylic acid may further be present within any range delimited by any pair of the foregoing values, such as between 0.5 ppm and 1000 ppm, or between 1 ppm and 100 ppm, for example. The term “ppm” as used herein means part per million by weight or volume, for example, the weight of the component (in milligrams) per liter of solution, i.e., μg/ml.

The phrase “food product” as used herein includes, but is not limited to, fruits, vegetables, juices, meat products (e.g., ham, bacon and sausage), egg products, fruit concentrates, gelatins and gelatin-like products (e.g., jams, jellies, preserves, and the like) milk products (e.g., ice cream, sour cream and sherbet), icings, syrups including molasses, corn products, wheat products, rye products, soybean products, oat products, rice products and barley products, nut meats and nut products, cakes, cookies, confectionaries (e.g., candies, gums, fruit flavored drops, and chocolates), chewing gum, mints, creams, ice cream, pies and breads, and beverages such as coffee, tea, carbonated soft drinks (e.g., soft drinks sold under the tradenames COKE® and PEPSI®)), non-carbonated soft drinks, juices and other fruit drinks, sports drinks such as those sold under the tradename GATORADE®, alcoholic beverages, such as beers, wines and liquors, and flavored drinks such as those sold under the tradename KOOL-AID®. Food products also include condiments such as herbs, spices and seasonings, and flavor enhancers, such as monosodium glutamate. A food product also includes prepared packaged products, such as dietetic sweeteners, liquid sweeteners, granulated flavor mixes which upon reconstitution with water provide non-carbonated drinks, instant pudding mixes, instant coffee and tea, coffee whiteners, malted milk mixes, pet foods, livestock feed, tobacco, and materials for baking applications, such as powdered baking mixes for the preparation of breads, cookies, cakes, pancakes, donuts and the like. Food products also include diet or low-calorie food and beverages containing little or no sucrose. Especially preferred food products are carbonated beverages. Preferably, the consumable in which the sweetness or mouthfeel is enhanced contains a decreased level of the carbohydrate sweetener. For example, an improved carbonated soft drink can be produced with the same sweetness as the known carbonated soft drink but with a lower sugar content by adding the B. nivea extract and/or dicarboxylic acid of the invention.

The consumable can also be a pharmaceutical composition. Preferred compositions are pharmaceutical compositions containing the B. nivea extract and/or dicarboxylic acid and one or more pharmaceutically acceptable excipients. These pharmaceutical compositions can be used to formulate pharmaceutical drugs containing one or more active agents that exert a biological effect other than sweetness enhancement. The pharmaceutical composition preferably further includes one or more active agents that exert a biological effect. Such active agents include pharmaceutical and biological agents that have an activity other than taste enhancement. Such active agents are well known in the art. See, e.g., The Physician's Desk Reference. Such compositions can be prepared according to procedures known in the art, for example, as described in Remington's Pharmaceutical Sciences, Mack Publishing Co., Easton, Pa. In one embodiment, such an active agent includes bronchodilators, anorexiants, antihistamines, nutritional supplements, laxatives, analgesics, anesthetics, antacids, H₂-receptor antagonists, anticholinergics, antidiarrheals, demulcents, antitussives, antinauseants, antimicrobials, antibacterials, antifungals, antivirals, expectorants, anti-inflammatory agents, antipyretics, and mixtures thereof. In one embodiment, the active agent is a antipyretic or analgesic, e.g., ibuprofen, acetaminophen, or aspirin; laxative, e.g., phenolphthalein dioctyl sodium sulfosuccinate; appetite depressant, e.g., amphetamine, phenylpropanolamine, phenylpropanolamine hydrochloride, or caffeine; antacidic, e.g., calcium carbonate; antiasthmatic, e.g., theophylline; antidiuretic, e.g., diphenoxylate hydrochloride; agent active against flatulence, e.g., simethecon; migraine agent, e.g., ergotaminetartrate; psychopharmacological agent, e.g., haloperidol; spasmolytic or sedative, e.g., phenobarbitol; antihyperkinetic, e.g., methyldopa or methylphenidate; tranquilizer, e.g., a benzodiazepine, hydroxinmeprobramate or phenothiazine; antihistaminic, e.g., astemizol, chloropheniramine maleate, pyridamine maleate, doxlamine succinate, bromopheniramine maleate, phenyltoloxamine citrate, chlorocyclizine hydrochloride, pheniramine maleate, or phenindamine tartrate; decongestant, e.g., phenylpropanolamine hydrochloride, phenylephrine hydrochloride, pseudoephedrine hydrochloride, pseudoephedrine sulfate, phenylpropanolamine bitartrate, or ephedrine; beta-receptor blocker, e.g., propanolol; agent for alcohol withdrawal, e.g., disulfuram; antitussive, e.g., benzocaine, dextromethorphan, dextromethorphan hydrobromide, noscapine, carbetapentane citrate, or chlophedianol hydrochloride; fluorine supplement, e.g., sodium fluoride; local antibiotic, e.g., tetracycline or cleocine; corticosteroid supplement, e.g., prednisone or prednisolone; agent against goiter formation, e.g., colchicine or allopurinol; antiepileptic, e.g., phenyloine sodium; agent against dehydration, e.g., electrolyte supplement; antiseptic, e.g., cetylpyridinium chloride; NSAID, e.g., acetaminophen, ibuprofen, naproxen, or salt thereof; gastrointestinal active agent, e.g., loperamide and famotidine; an alkaloid, e.g., codeine phosphate, codeine sulfate, or morphine; supplement for a trace element, e.g., sodium chloride, zinc chloride, calcium carbonate, magnesium oxide, or other alkali metal salt or alkali earth metal salt; vitamin; ion-exchange resin, e.g., cholestyramine; cholesterol-depressant or lipid-lowering substance; antiarrhythmic, e.g., N-acetylprocainamide; or expectorant, e.g., guaifenesin.

In some embodiments, the consumable is a dietary supplement or nutraceutical. Examples of such compositions having an undesirable taste include, but are not limited to, enteral nutrition products for treatment of nutritional deficit, trauma, surgery, Crohn's disease, renal disease, hypertension, obesity and the like, to promote athletic performance, muscle enhancement or general well-being or inborn errors of metabolism such as phenylketonuria. In particular, such compositions can contain one or more amino acids which have a bitter or metallic taste or aftertaste. Such amino acids include, but are not limited to, essential amino acids such as L isomers of leucine, isoleucine, histidine, lysine, methionine, phenylalanine, threonine, tryptophan, tyrosine, and valine.

In a further embodiment, the consumable of the present invention is a dental hygienic composition, containing a carbohydrate sweetener or flavoring and the B. nivea extract and/or dicarboxylic acid. Dental hygienic compositions are known in the art and include, but are not necessarily limited to, toothpaste, mouthwash, plaque rinse, dental floss, dental pain relievers (such as a pain reliever sold under the tradename ANBESOL™), and the like. In one embodiment, the dental hygienic composition includes one carbohydrate sweetener. In another embodiment, the dental hygienic composition includes more than one carbohydrate sweetener. In certain embodiments, the dental hygienic composition includes sucrose and corn syrup, or sucrose and aspartame.

In yet another embodiment, the consumable of the present invention is a cosmetic product containing a carbohydrate sweetener or flavoring and the B. nivea extract and/or dicarboxylic acid. For example, but not by way of limitation, the cosmetic product can be a face cream, lipstick, lip gloss, and the like. Other suitable compositions of the invention include lip balm, such as lip balms sold under the tradenames CHAPSTICK® and BURT'S BEESWAX®.

When used in the methods and compositions of this invention, the B. nivea extract and/or dicarboxylic acid is added to a consumable (i.e., the sebacic acid is not an endogenous component of the consumable) in an amount effective to enhance the sweetness or mouthfeel of the consumable including a carbohydrate sweetener or flavoring. In this respect, the amount of carbohydrate sweetener or flavoring added to the consumable may be reduced while retaining the desired sweetness level. Thus, the present invention also provides methods and compositions for enhancing the sweetness and mouthfeel of a carbohydrate sweetener and/or flavoring and decreasing the amount of a carbohydrate sweetener and/or flavoring in a consumable by combining the carbohydrate sweetener and/or flavoring with the B. nivea extract and/or dicarboxylic acid of the invention. In certain embodiment, the B. nivea extract or dicarboxylic acid is employed in a carbohydrate sweetener or flavoring at about 0.05 parts per million or greater by weight, preferably at from about 0.5 part to about 1000 parts per million by weight, more preferably at from about 1 part to about 100 parts per million by weight and even more preferably at from about 5 to about 50 parts per million by weight. The term “ppm” is understood to mean part per million by weight.

The B. nivea extracts and/or dicarboxylic acids can also be used in consumables to mask unpleasant, off-flavors of proteinaceous components of a consumable. In this respect, the present invention also provides compositions and methods for masking a proteinaceous off-flavor of a consumable by adding a B. nivea extract and/or dicarboxylic acid to the consumable in an amount effective to mask the proteinaceous off-flavor of the consumable. In some embodiments, the proteinaceous off-flavor is associated with a proteinaceous component such as an amino acid, protein hydrolysate or protein component that imparts a bitter, sour, astringency, drying, and/or metallic taste. Ideally, the B. nivea extract and/or dicarboxylic extract reduces the proteinaceous off-flavor taste by at least about 10%, 20%, 30%, 40%, 50%, 60%, 70%, 80%, 90%, or 95%, or from about 60% to about 99%, or alternatively from about 20% to about 50% compared to the consumable not including the B. nivea extract and/or dicarboxylic acid.

The invention is described in greater detail by the following non-limiting examples.

### Example 1: Preparation of B. nivea Extract

B. nivea leaves (200 g) were extracted with water, ethanol or a mixture of water and ethanol (2 L) at room temperature or at a temperature ranging from 20 to 80° C. The extract was then filtered using a filter paper and concentrated with a rotary evaporator at a reduced pressure (5 Hectopascal) to provide a B. nivea extract.

The B. nivea extract analyzed and found to include traumatic acid, 3-dodecenedioic acid and sebacic acid, wherein the weight ratio of traumatic acid and 3-dodecenedioic acid vs. sebacic acid ranged from about 10:1 to 100:1, or more particularly from about 20:1 to 40:1.

### Example 2: Sensory Evaluation of B. nivea Extract at Different Amount in Sugar Water

Sugar water (4% sucrose in drinking water) was prepared and used as a base solution. B. nivea extract (as prepared in Example 1) was added to the sugar water and descriptive sensory evaluations were performed (Table 1).

TABLE 1

| Extract (ppm) | Taste Evaluation |
|---|---|
| 0.05 | Slight sweet and mouthfeel |
| | enhancement, barely detectable |
| 1000 | Strong sweet and mouthfeel |
| | enhancement with strong herbal |
| | off-taste |

### Example 3: Sensory Evaluation of Traumatic Acid and 3-Dodecenedioic Acid in Sugar Water

Sugar water (4% sucrose in drinking water) was prepared and used as a base solution. Traumatic acid (purchased from Cayman Chemical Company) and 3-dodecenedioic acid (isolated from a B. nivea extract) were added to the sugar water and taste descriptive sensory evaluations were performed (Table 2).

TABLE 2

| Compound (5 ppm) | Taste Evaluation |
|---|---|
| Traumatic acid | Sweeter than the base |
| | solution, mouthcoating, fatty |
| | sensation |
| 3-Dodecenedioic acid | Sweeter than the base |
| | solution, fruity, fatty |
| | sensation |

This analysis indicated that both traumatic acid and 3-dodecenedioic acid enhanced the sweetness and mouthfeel of sugar water.

### Example 4: Taste Modulation Using Ramie Extract

A water and ethanol extract of B. nivea leaves was prepared and descriptive sensory evaluations were carried out using different amounts of the B. nivea extract in different applications. The results of this analysis, as compared to the same applications in the absence of B. nivea extract, are presented in Table 3.

TABLE 3

| Application | Extract | Taste Evaluation |
|---|---|---|
| Water | 40 ppm | Flavor is similar to black |
| | | tea |
| 3% Sugar + 0.05% | 40 ppm | Flavor is similar to black |
| Citric Acid Water | | tea. |
| Solution | | |
| 3% Sugar-Sweetened | 20 ppm | Very sweet/coconutty, |
| Full Fat Milk | | creamier mouthfeel, almost |
| | | like drinking full fat ice |
| | | cream |
| 3% Sugar-Sweetened | 20 ppm | Tastes coconutty, does |
| Non-Fat Milk | | nothing for sweetness or |
| | | mouthfeel |
| Almond Milk (1% | 20 ppm | Creamy mouthfeel, covers |
| Fat, 2.8% Sugar) | | some of the nut notes, adds |
| | | a small amount of sweetness |
| Flax Milk (1% Fat, | 20 ppm | Less seedy tasting, more |
| 2.8% Sugar) | | mouthcoating, fatty end |
| Unsweetened Soy | 20 ppm | Sits on bean notes, adds |
| Milk (1.4% Fat, | | sweetness |
| 0.4% Sugar) | | |
| Unsweetened Pea | 30 ppm | Milky, covers protein off- |
| Protein Beverage | | note, creamier |
| (0.4% Fat, 5% | | |
| Protein) | | |
| Strawberry | 60 ppm | Increases creaminess, makes |
| Flavored Yogurt | | taste higher fat, covers |
| (5% Sugar, 0.4% | | acid |
| Fat, 8.7 Grams | | |
| Protein) | | |
| Strawberry | 60 ppm | Sits on flavor slightly, not |
| Flavored Yogurt | | a positive affect |
| (5% Sugar, 0.0% | | |
| Fat, 9 Grams | | |
| Protein) | | |
| Mixed Berry Yogurt | 15 ppm | Increased creaminess, tastes |
| Smoothie (1% Fat, | | higher fat, tastes sweeter, |
| 9% Sugar, 3% | | increases strawberry flavor |
| Protein) | | perception |

### Example 5: Taste Modulation Using Traumatic Acid

Descriptive sensory evaluations were carried out using different amounts of traumatic acid in different applications. The results of this analysis, as compared to the same applications in the absence of traumatic acid, are presented in Table 4.

TABLE 4

| | Traumatic | |
|---|---|---|
| Application | Acid | Taste Evaluation |
| Water | 40 ppm | Fatty and oily |
| 3% Sugar + 0.05% | 40 ppm | Fatty and oily |
| Citric Acid Water | | |
| Solution | | |
| 3% Sugar-Sweetened | 7.5 ppm | Enhances fatty perception |
| Full Fat Milk | | and creaminess, makes |
| | | similar to sweet cream |
| Strawberry | 15 ppm | Sweet up front, more |
| Flavored Yogurt | | strawberry |
| (5% Sugar, 0.4% | | |
| Fat, 8.7 Grams | | |
| Protein) | | |
| Mixed Berry Yogurt | 7.5 ppm | More sweet creamy, milkier |
| Smoothie (1% Fat, | | than control, more indulgent |
| 9% Sugar, 3% | | |
| Protein) | | |

### Example 6: Taste Modulation Using Sebacic Acid

Descriptive sensory evaluations were carried out using different amounts of sebacic acid in different applications. The results of this analysis, as compared to the same applications in the absence of sebacic acid, are presented in Table 5.

TABLE 5

| | Sebacic | |
|---|---|---|
| Application | Acid | Taste Evaluation |
| Water | 40 ppm | Fatty and oily |
| 3% Sugar + 0.05% | 40 ppm | Fatty and oily |
| Citric Acid Water | | |
| Solution | | |
| 3% Sugar-Sweetened | 7.5 ppm | Increases fatty perception |
| Full Fat Milk | | and enhances mouthfeel |
| Strawberry | 15 ppm | Sweet up front, more |
| Flavored Yogurt | | strawberry, cuts acid |
| (5% Sugar, 0.4% | | |
| Fat, 8.7 Grams | | |
| Protein) | | |
| Mixed Berry Yogurt | 7.5 ppm | Cuts sour end, increased |
| Smoothie (1% Fat, | | sweet milk notes |
| 9% Sugar, 3% | | |
| Protein) | | |

In addition, the sweetness and mouthfeel enhancement as well as off-flavor masking of sebacic acid was compared with a series of analogs including adipic acid, pimelic acid, suberic acid, undecanedioic acid, dodecanedioic acid, 1,11-undecanedicarboxylic acid, tetradecanedioic acid and hexadecanedioic acid at 2 ppm. Among all the compounds tested, traumatic acid, 3-dodecenedioic acid, and sebacic acid exhibited the strongest and the longest-lasting effect, which was significantly superior to all other compounds tested.

What is claimed is:

1. A consumable comprising
(a) a carbohydrate sweetener or flavoring and
(b) Boehmeria nivea extract or at least one dicarboxylic acid.

2. The consumable of claim 1, wherein the dicarboxylic acid has the structure of Formula I: 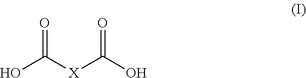
wherein X is a C₆-C₁₂ alkyl or alkenyl group.

3. The consumable of claim 2, wherein the dicarboxylic acid is saturated, mono-unsaturated or di-unsaturated.

4. The consumable of claim 3, wherein the saturated dicarboxylic acid is decanedioic acid.

5. The consumable of claim 3, wherein mono-unsaturated dicarboxylic acid is 2-dodecenedioic acid, 3-dodecenedioic acid, or a combination thereof.

6. The consumable of claim 1, wherein said consumable comprises a mixture of decanedioic acid and at least one mono-unsaturated dicarboxylic acid.

7. The consumable of claim 6, wherein the at least one mono-unsaturated dicarboxylic acid is 2-dodecenedioic acid, 3-dodecenedioic acid, or a combination thereof.

8. The consumable of claim 1, wherein the Boehmeria nivea extract is glucosylated.

9. The consumable of claim 1, wherein the consumable is a food product, pharmaceutical composition, a dietary supplement, a nutraceutical, a dental hygienic composition, a tabletop sweetener, a beverage, or a cosmetic product.

10. A method of enhancing the sweetness or mouthfeel of a consumable including a carbohydrate sweetener or flavoring comprising adding at least one dicarboxylic acid or a Boehmeria nivea extract to the consumable in an amount effective to enhance the sweetness or mouthfeel of the consumable.

11. The method of claim 10, wherein the dicarboxylic acid has the structure of Formula I: 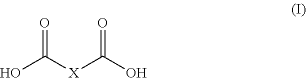
wherein X is a C₆-C₁₂ alkyl or alkenyl group.

12. The method of claim 10, wherein the dicarboxylic acid is a mixture of a mono-unsaturated acid and decanedioic acid, wherein the mono-unsaturated acid is 2-dodecenedioic acid, 3-dodecenedioic acid or a mixture thereof.

13. The method of claim 10, wherein the Boehmeria nivea extract is glucosylated.

14. The method of claim 10, wherein the amount is in the range of 0.5 ppm to 1000 ppm.

15. The method of claim 10, wherein the amount is in the range of 1 to 100 ppm.

16. The method of claim 10, wherein the consumable is a food product, pharmaceutical composition, a dietary supplement, a nutraceutical, a dental hygienic composition, a tabletop sweetener, a beverage, or a cosmetic product.

17. A consumable comprising a proteinaceous component and a Boehmeria nivea extract.

18. The consumable of claim 17, wherein the Boehmeria nivea extract is glucosylated.

19. The consumable of claim 17, wherein the consumable is a food product, pharmaceutical composition, a dietary supplement, a nutraceutical, a dental hygienic composition, a tabletop sweetener, a beverage, or a cosmetic product.

20. A method of masking a proteinaceous off-flavor of a consumable comprising adding a Boehmeria nivea extract to the consumable in an amount effective to mask the proteinaceous off-flavor of the consumable.

21. The method of claim 20, wherein the Boehmeria nivea extract is glucosylated.

22. The method of claim 20, wherein the consumable is a food product, pharmaceutical composition, a dietary supplement, a nutraceutical, a dental hygienic composition, a tabletop sweetener, a beverage, or a cosmetic product.
